(19) United States
(12) Patent Application Publication
(10) Pub. No.: US 2018/0360010 A1
(43) Pub. Date: Dec. 20, 2018

(54) System, Apparatus and Methods for Organism Immobilization

(71) Applicant: Lee Carstensen, Vancouver, WA (US)

(72) Inventor: Lee Carstensen, Vancouver, WA (US)

(21) Appl. No.: 16/056,197

(22) Filed: Aug. 6, 2018

Related U.S. Application Data
(63) Continuation-in-part of application No. 13/164,756, filed on Jun. 20, 2011, now abandoned.
Application No. 13/164,756 is a continuation-in-part of application No. 15/224,638, filed on Jul. 31, 2016, now abandoned.
(60) Provisional application No. 61/356,375, filed on Jun. 18, 2010.
(60) Provisional application No. 62/199,966, filed on Jul. 31, 2015.

(51) Int. Cl. A01K 79/02; A41D 19/00

(52) U.S. Cl. CPC A01K 79/02; A01K 15/029; A41D 19/0006

(57) ABSTRACT

A portable system for handling and affecting a physiological state of an aquatic species with a pair of gloves, a multiplicity of electrodes, and a pulsator attached to the electrodes, so that when the pulsator is activated the current, alters the physiological state of the aquatic species. The system providing a regulated current output to control the flow of current through the aquatic species held between the pair of conducting gloves.

### RELATED APPLICATIONS

This application is a Continuation-in-part (CIP) application of Utility application Ser. No. 13/164,756 filed on Jun. 20, 2011, entitled as “Systems and Methods for the Handling of Aquatic Species”, which claims benefit of U.S. provisional application No. 61/356,375, filed on Jun. 18, 2010, the contents herein incorporated into this application by reference. This application is also a Continuation-in-part (CIP) application of U.S. Utility application Ser. No. 15/224,638 filed on Jul. 31, 2016 entitled as “Organism immobilization Apparatus”, which claims the benefit of U.S. provisional application No. 62/199,966, filed on Jul. 31, 2015, the contents herein incorporated into this application by reference.

### BACKGROUND

The present inventive subject matter relates to the systems and methods for the handling of aquatic species using electrified gloves.

Electrofishing has traditionally been used in freshwater lakes and streams and is the subject of U.S. Pat. Nos. 5,445,111; 5,327,854; 4,750,451; 4,672,967; 4,713,315; 5,111,379; 5,233,782; 5.270,912; 5,305,711; 5,311,694; 5,327,668; 5,341,764; 5,551,377; and 6,978,734 which are incorporated herein by reference.

A recurring problem with the examination of laboratory fish is that hey tend to be very active. The small size of the fish combined with their activity can impair the researcher from making precise scientific measurements unless the fish is caught and inspected. Thus, direct examination of fishes is preferred to “in situ” measurements.

A safe and portable method is desired for anesthetizing fish to minimize stress on the fish while scientists are handling and inspecting them. Prior art solutions and techniques to induce anesthesia in fish involve the addition of chemicals to the tank. See U.S. Pat. Nos. 3,551,566; 3,644,625; and 4,807,615; which are incorporated by reference. Chemicals used for anesthesia are expensive to acquire, pose a storage and maintenance problem, and are at risk of degradation. Prior art solutions and techniques to induce anesthesia in fish without the addition of chemicals to the tank involve a safe way to anesthetizing fish in the holding tank of a boat. See U.S. Pat. No. 8,087,384; which is incorporated by reference. This system requires installation and use of equipment onboard a boat.

Therefore, what is desired is an apparatus to immobilize fish and place the fish in an anesthesia state while in a laboratory setting. It is also desired that the apparatus pose little or no attendant risk to any of the researchers whom are close to the holding tank. It is also desired that this apparatus can operate without significant modification to the laboratory infrastructure. It is also desired that this apparatus operate without the use of chemical additives.

### SUMMARY

The present inventive subject matter overcomes problems in the prior art by providing for systems and methods for an apparatus to handle and affect the physiological state of an aquatic species, said apparatus having a pair of gloves, a multiplicity of electrodes, said electrodes attached to each glove; a pulsator, said pulsator attached to the electrodes; such that when the pulsator is activated, and the aquatic species is handled by the gloves, the current passing from one electrode to another, alters the physiological state of the aquatic species.

Another example of the inventive subject matter is a method for the handling and affecting the physiological state of an aquatic species, said method comprising the steps of handling the aquatic species with a pair of gloves, wherein said gloves further comprise a multiplicity of electrodes, wherein said electrodes are attached to each glove, and a pulsator, said pulsator attached to the electrodes; connecting the gloves to a pulsator, activating the pulsator, such that when the pulsator is activated, the physiological state of the aquatic species is affected.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a front view of the pair of gloves with the embodiment of the inventive subject matter.

FIG. 2 is a view of the gloves with the inventive subject matter connected to a pulsator.

FIG. 3 is system diagram of the inventive subject matter.

FIG. 4 is close in view of a glove with an electrode and a switch mounted to the glove.

FIG. 5 is a diagram of the glove being used in connection with fish processing.

FIG. 6 is a diagram of the glove being used on an electrofishing boat.

FIGS. 7A-7D is an alternate embodiment of the gloves with conductive material/electrodes being placed on various places on the gloves.

FIG. 8 is a view of the inventive subject matter used proximate to a holding tank.

FIG. 9A-9C is a schematic of an alternate embodiment for a constant current pulsator.

FIG. 10A-10B is a block diagram of the alternate embodiment.

FIG. 11 displays contents of the fish handling kit.

FIG. 12 displays an image of fish handling system worn on a user's body.

FIG. 13. displays the image of control box to adjust the output current.

FIG. 14 displays an image of a fish handling gloves on a user's hand.

### DETAILED DESCRIPTION

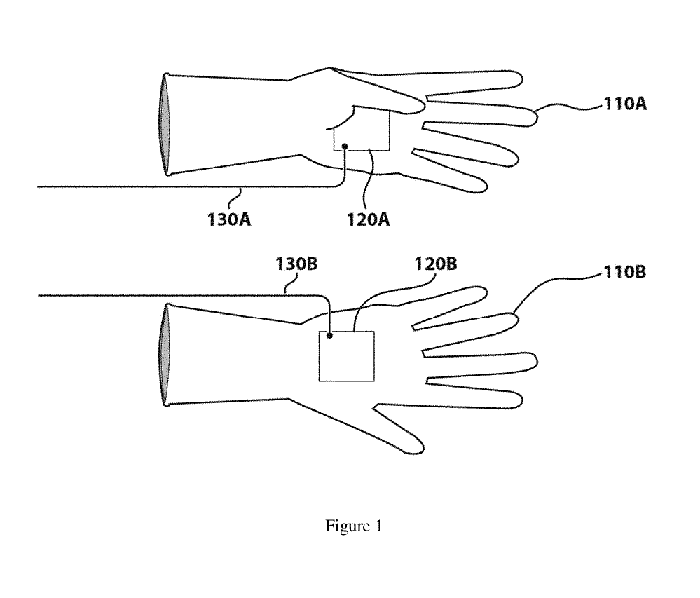

Representative embodiments according to the inventive subject matter are shown in FIGS. 1-14 wherein similar features share common reference numerals.

Now referring to FIG. 1 which depicts the inventive subject matter of the gloves 110A, 110B, attached to the gloves are conductive materials/electrodes 120A, 120B, which are attached by wires 130A, 130B to an electric power source (not shown). The gloves 110A, 110B would typically be impermeable, non-conducting, water resistant gloves that are well known in the arts. Such gloves may be made from plant materials, such as rubber gloves; the gloves may also be made from animal products, such as deer and/or cow, and sealed to prevent permeation of water; or the gloves may also be made from a synthetic material, such as, synthetic rubber, and/or polyethylene. The gloves should be thick enough to prevent any chance of conductivity. The electrodes attached to the glove can be made from any number of conductive materials, such as, aluminum, copper, silver, gold, or alloys of other metals with the aforementioned conductive materials. The conductive materials can be infused into a top layer of the glove or the conductive material may be attached separated in the form of a strap or tape. The important aspect of the conductive material is that it will move in concert with the palm and/or fingers of the glove so that when an object is gripped the conductive material will come into contact with the gripped object.

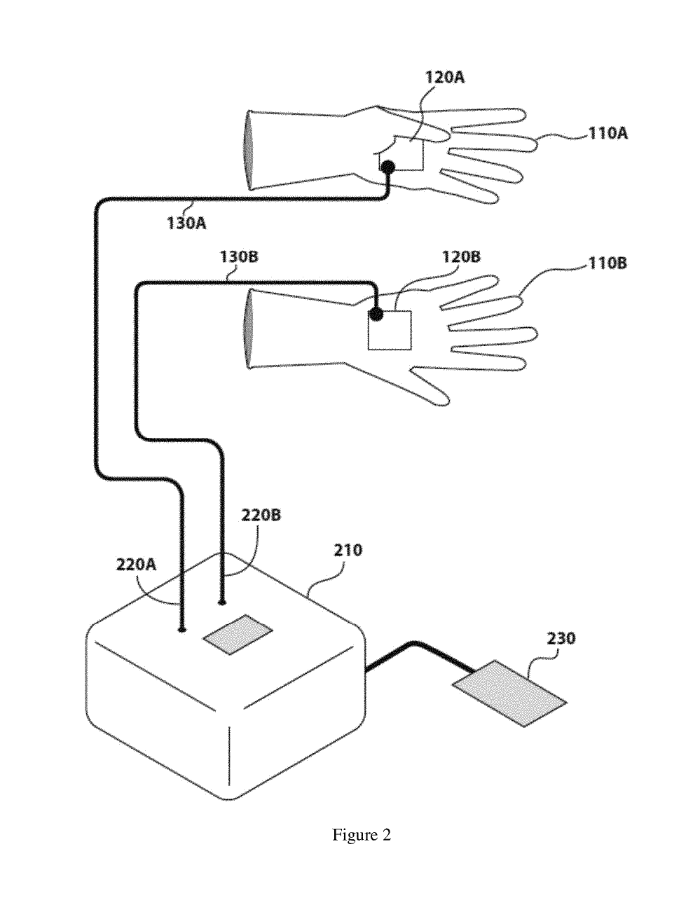

Now referring to FIG. 2 which shows the gloves 110A, 110B, the gloves 110A, 110B are connected to the conductive materials/electrodes 120A, 120B, which are connected by wires 130A, 130B to the electrical terminals 220A, 220B of a pulsator 210. The pulsator 210 is operated by a switch 230, so that the conductive materials/electrodes 120A, 120B are energized when the switch is closed 230. The voltage and current passing through the wires 130A, 130B is dependent on the settings of the pulsator 210 and the object held between the conductive materials/electrodes 120A, 120B.

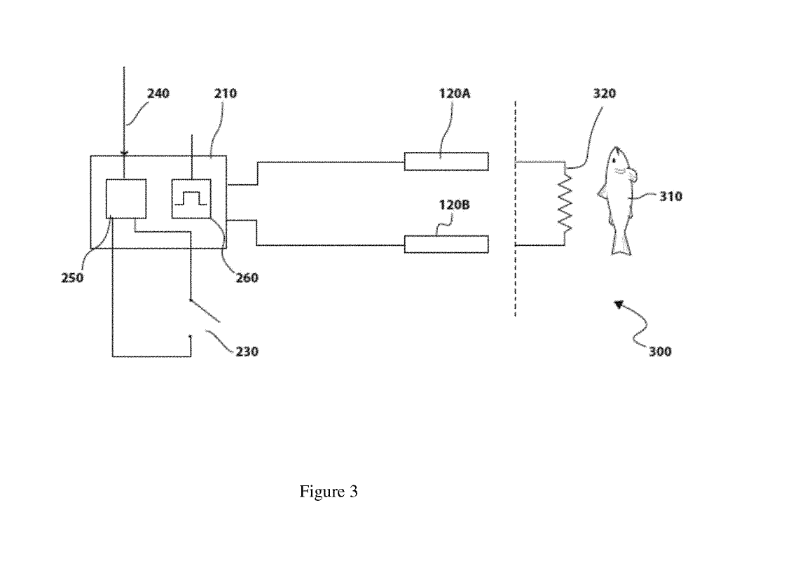

Now referring to FIG. 3 which illustrates a schematic 300 of the aforementioned FIGS. 1 and 2. In FIG. 3, the conductive materials/electrodes 120A, 120B are typically placed proximate to and in a conductive media (e.g. freshwater or saltwater) that surrounds a fish 310. The term “fish” not being limited to the small class of fish-like species, rather all aquatic animals that are confined in a liquid solution, typically being freshwater, saltwater, and/or brackish water. The electrical current flows from one side of the conductive material/electrode 120A and through the fish 310 to the other conductive material/electrode 120B and through the fish 310.

The current passing through the fish causes a physiological reaction in the fish leading to immobilization of fish. Therefore, in referring back to FIG. 3, in conjunction with FIGS. 1 and 2, that the use of a pulsator 210 with a variable voltage setting 240, a power source 250, an external power switch 230, and a waveform modulator 260 can produce a power source that can immobilize or stun a fish.

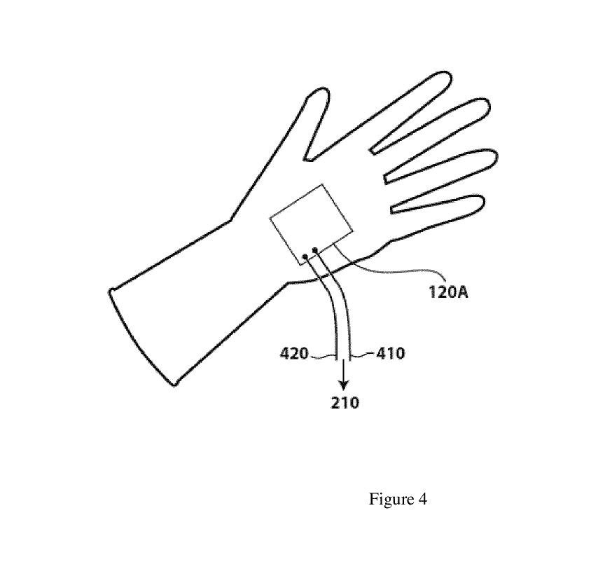

Now referring to FIG. 4 which depicts a variation of the glove and the conductive material/electrode 120A which also incorporates a pressure sensitive switch 410/420. This pressure sensitive switch 410/420 can be used to turn on/turn off the application of voltage from the pulsator 210. In these circumstances the voltage will only be applied when the glove grasps a fish. This “glove switch” can be used in the conjunction with an external power switch so that a fish can be grasped with no electricity applied, then the external power switch used to apply electricity to the fish.

Now referring to FIG. 5 which shows the use of the inventive subject matter in a fish processing application 500. The fish 510 are transported down a conveyor 520 and grasped by the gloves 110A, 110B. The external power switch 230 is used to activate the pulsator 210, so that current passes through the gloves 110A, 110B and through the fish 510.

Now referring to FIG. 6 which illustrates the use of the gloves 110A, 110B which pass current through a fish 630 on a platform 620 mounted on a boat 610.

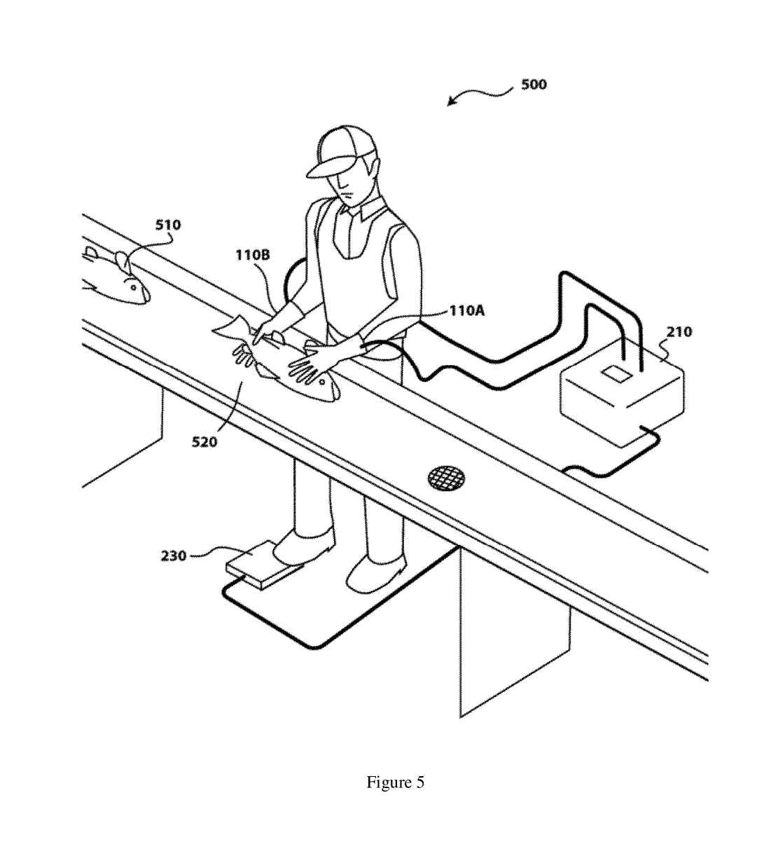

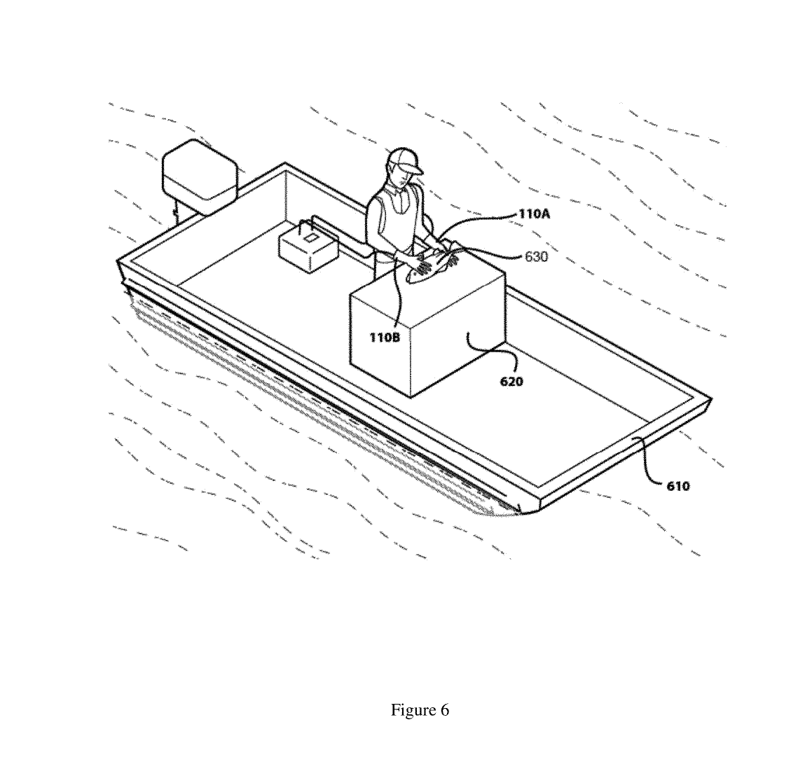

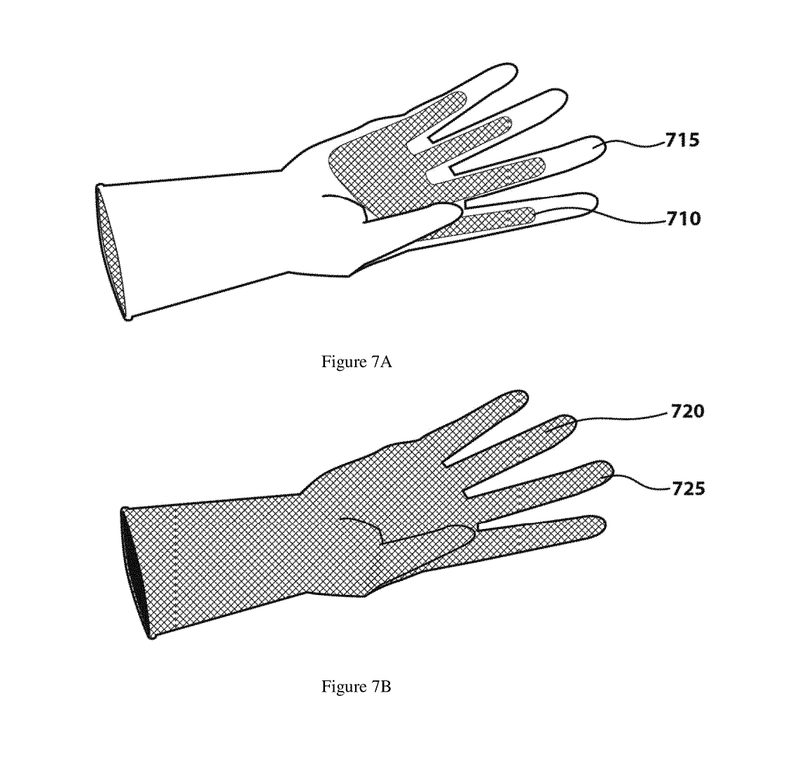

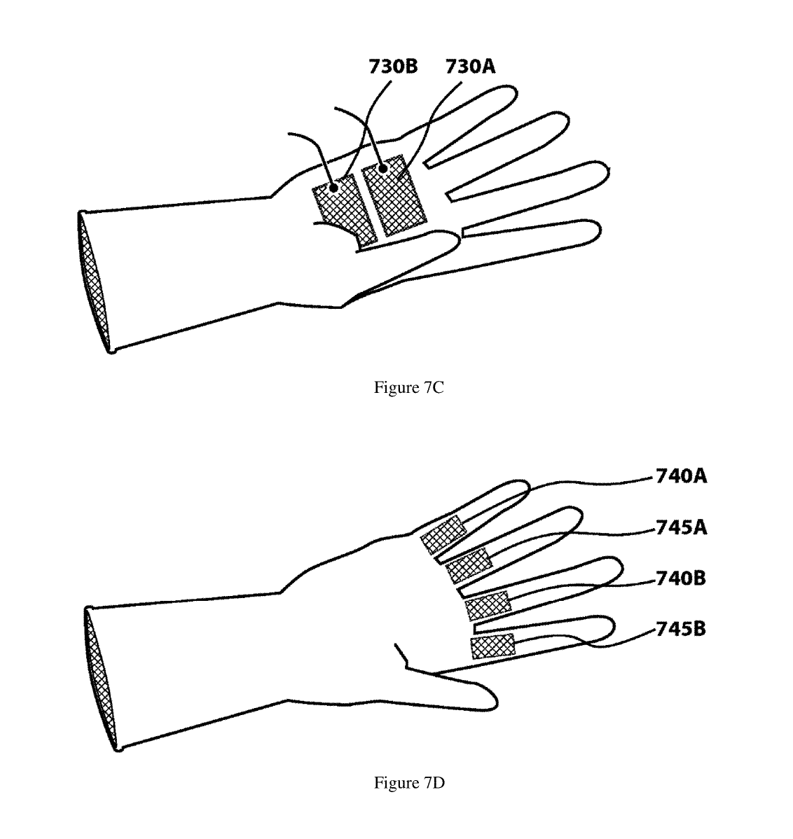

Now referring to FIGS. 7A-7D, which illustrates different embodiments of the conductive material on the gloves. For example, FIG. 7A shows the conductive material 710 being on the palm and also applied to a finger 715. FIG. 7B shows the conductive material being applied to the entire glove including the fingers. FIG. 7C illustrates the placement of opposite polarity electrodes 730A, 730B on the palm of the hand. FIG. 7D depicts the use of alternating opposite electrodes on the fingers of the hand 740A/B or 745A/B. The constant current compensates for differences in contact with the fish by each of the gloves, and also has inherent safety aspects. It is clear to one skilled in the arts that there are many variations of the electrodes that may be employed.

Now referring to FIG. 8 which shows the use gloves connected to a pulsator 210. The pulsator 210 is connected to the gloves 810A and 810B through connecting wires 830A and 830B respectively. The gloves 810A, 810B are placed in the water 860 proximate to the fish 850 in a water tank 810, which causes and electric field to be impressed across the fish 850.

### Details of Electrical Circuit Connections for Fish Handling Gloves System

In an embodiment for the fish handling gloves system, FIG. 9A-9C depicts a split portrait format for a constant current electroanesthesia device employed in the fish handling gloves system. The constant current electroanesthesia device provides a constant current across and through the body of the fish. In situations where the fish has lower resistance (higher conductivity), the constant current creates a lower potential difference (E=IR). Where the fish has a higher resistance (lower conductivity), the constant current creates a higher potential difference.

A block diagram representation of the electroanaesthesia device is as shown in FIG. 10A-10B. As illustrated in FIG. 10A, a current output in the range 4 mA to 25 mA 1010 is output by a current source connected to the cathode of the glove 1005A and the anode of the glove 1005B. The range of battery voltage for normal operation 1020 is 32V-36V. A battery charger 1030 is equipped with a power on and automatic charging disconnect switch 1040. Further the current output source is equipped with indicators for indicating power on, out of compliance and low battery charging indicator 1050. As illustrated in FIG. 10B, a constant current electroanesthesia device 1060 is connected to the cathode of the glove 1005A and the anode of the glove 1005B, such that the gloves 1005A and 1005B can grasp a fish 1003.

The above described Fish Handling Gloves are lightweight, water-proof, portable and designed to temporarily immobilize live fish for easier handling. These gloves are electrified to pass levels of manually adjustable electric current through the body of a fish. A recovery of motion occurs for the fish upon release from the fish handling gloves system.

### Portable Electrical Fish Handling Gloves System

Now referring to FIG. 11, 1100 refers to the components of a fish handling portable kit. The kit consists of a pair of conductive fish handling gloves 1110, a pair of rubber insulating gloves 1115, control box 1120, wire leads 1125, battery charger 1130, a carry case 1135, a chest or body harness 1140, a wrist or arm bands 1145 and user manual 1150. The control box 1120 is designed to be light weight and water proof and carries rechargeable batteries.

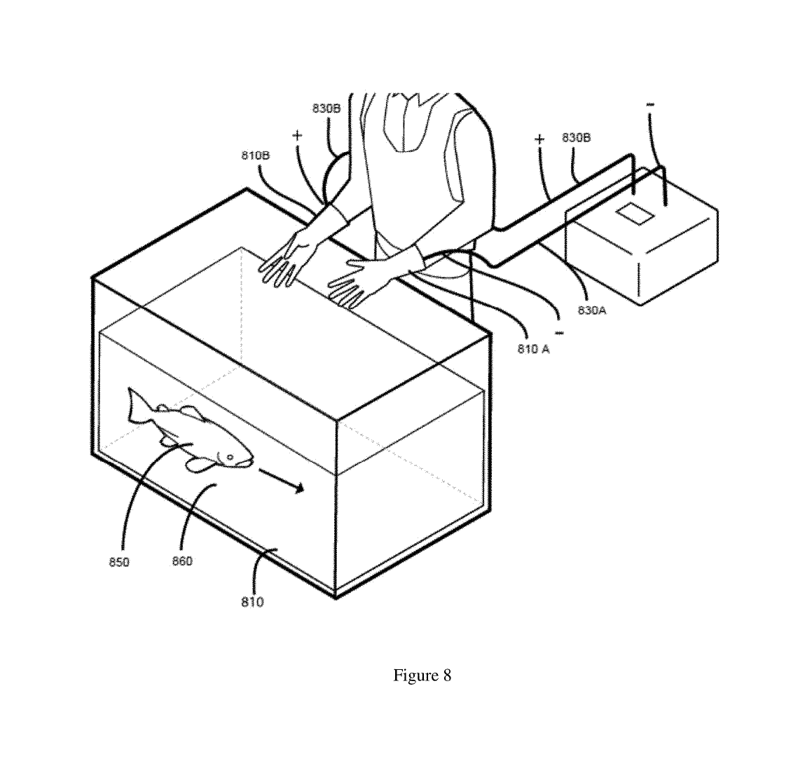

In an embodiment as illustrated in FIG. 12, the light weight and water-resistant control box 1120 can be worn on a user's body 1200 with the chest harness 1140 or in alternative embodiments the control box 1120 clipped on a belt making the device fully portable in either case, during the fish handling process.

As illustrated in FIG. 12, two sets of gloves must be worn when operating the fish handling glove system 1100. A pair of rubber insulating Gloves 1115 insulates the handler from the electric current and is worn under the pair of Fish Handling Gloves 1110. The conductive fish handling gloves 1110 are worn over the rubber gloves 1115 and are connected to the Control Box 1120 with the wire leads 1125. On one hand, a fish handling glove acts as the negative terminal (cathode) and on the other hand the glove is the positive terminal (anode). The circuit is completed and current will flow when an electric current setting is selected on the control box 1120 and a fish is contacted by each of the fish handling gloves 1110 simultaneously.

As illustrated in FIG. 13, a top 1300 of the control box 1120 has a rotary switch 1310 to adjust the output current. The switch has six positions and sets the output current selection to either OFF-1311, 4.0 mA (milliamps)-1312, 6.3 mA-1313, 10.0 mA-1314, 16.0 mA-1315 or 25.0 mA-1316. In the off position-1311, the equipment will not conduct electricity and the fish handling gloves are disabled.

The top 1300 of the control box 1120 has three indicator lights. The green indicator light-1321 illuminates when the power is on and the internal battery voltage is sufficient. The red indicator light-1322 illuminates when the internal battery voltage needs to be recharged. The yellow indicator light-1323 illuminates when the battery charger is plugged into the control box. During the battery charging operation, the gloves are fully disabled.

Now referring to FIG. 14, a flow chart for a method steps of handling of the fish with the electric fish handling gloves is described above. Initially it is ensured that the rotary switch 1310 on the control box is in the OFF position 1311 (step-1-1410), then the wire lead 1125 is connected to the control box 1120 via an output charger (step-2-1420), next the control box 1120 is clipped on to a convenient location on the body of the user using a harness 1140 (step-3-1430) where the wire lead will not become a tangling or tripping hazard. A pair of rubber insulating gloves 1115 is worn on both the palms and secured by elastic bands 1145 on the forearm and the upper arm to hold them securely in their positions (step-4-1440). A pair of conducting gloves 1110 is worn on the rubber insulating gloves 1115 (step-5-1450). Snap a wire lead onto each of the snaps on the conductive fish handling gloves (step-6-1460), preferably a red/positive electrode on the gloves intended to handle the head part of the fish. Saturate the fish handling gloves 1110 with water (step-7-1470). Select 4 mA current output setting 1312 on the rotary switch 1310 on the control box 1120 (step-8-1480). Handle the fish, while simultaneously monitoring the health of the fish to ensure proper current output settings (step-9-1490). Lastly, turn the rotary switch to OFF position 1311 (step-10-1495).

In an exemplary embodiment a pair of typical fish handling gloves system will have the following specifications. A power source ranging between 8.5-9.5 Volt rechargeable with a Nickel-metal hybrid battery. A battery voltage for normal operation being 32V-36 V and the battery shutdown voltage being 30 volts. Estimated battery life at 25 degrees celsius at 25 mA range for 4.5-5.5 hours, at 16 mA range for 8.5-9.5 hours, at 10 mA range for 12.5-13.5 hours, at 6.3 mA range for 17.5-18.5 hours and at 4 mA range for 24.5-25.5 hours. An output voltage being a maximum of 35-37 volts and a output current being a maximum of 24-26 milli-Amps. A normal storage temperature range of −20 deg C. to 30 deg. C. A dimensions of the control unit being, height in the range of 20.0-21 cms, width in the range of 11.5-12.5 cms depth in the range of 6.0-7.0 cms and weight in the range of 1.54-1.56 lbs.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

We claim:

1. A portable apparatus for immobilization of aquatic species, the apparatus comprising:
a pair of gloves, a first glove of the pair of gloves connected to an anode electrode and a second glove of the pair of gloves connected to a cathode electrode;
a control box, the control box connected to the cathode electrode and the anode electrode via wire leads and controlling the output of power to the anode electrode and the cathode electrode from a power source;
a harness adapted to be placed on a user's body and adapted to be attached to the control box;
such that when the user wears the pair of gloves on both of his/her hands and grips the aquatic species with the pair of gloves, a current passing from one electrode to another immobilizes the aquatic species.

2. The apparatus as described in claim 1, wherein the pair of gloves are worn over a pair of insulating gloves on the user's hands.

3. The apparatus as described in claim 1, wherein the electrodes attached to each glove move in concert with the user's hand movement so that the aquatic species gripped by the gloves will come in contact with the electrodes.

4. The apparatus as described in claim 1, used in handling aquatic species surrounded by a conductive media.

5. The apparatus as described in claim 1, further including a pressure sensitive switch in conjunction with an external switch.

6. The apparatus as described in claim 1, wherein the immobilization comprises a physiological state selected form a group consisting of flight, electrotaxis, electronarcosis or death.

7. The apparatus as described in claim 1, wherein the electrodes are made by conductive materials selected from a group consisting of aluminum, copper, silver or gold.

8. The apparatus as described in claim 1, wherein the electrodes are directly attached to a top layer of the gloves.

9. The apparatus as described in claim 1, wherein the electrodes are attached to a top layer of the gloves as strap or tape.

10. The apparatus as described in claim 1, wherein the electrodes are attached to a palm area of the gloves.

11. The apparatus as described in claim 1, wherein the electrodes are attached to a finger area of the gloves.

12. The apparatus as described in claim 1, wherein the electrodes are attached to a constant current electroanesthesia device.

13. A method for the handling and affecting the physiological state of an aquatic species, said method comprising the steps of:
ensuring that a rotary switch on a control box is in a OFF position;
connecting the wire lead to the control box via an output charger;
clipping the control box on to a convenient location on the body of a user using a harness;
wearing a pair of rubber insulating gloves on both the palms and securing by elastic bands on the forearm and the upper arm to hold them securely in their positions;
wearing a pair of conducting gloves on the rubber insulating gloves;
snapping a wire lead onto each of the snaps on the conductive fish handling gloves;
saturating the fish handling gloves with water;
selecting a current output setting by turning the rotary switch on the control box;
handling the fish and simultaneously monitoring the health of the fish to ensure proper current output settings; and
turning the rotary switch to the OFF position.
